(19) United States
(12) Patent Application Publication
(10) Pub. No.: US 2006/0088697 A1
(43) Pub. Date: Apr. 27, 2006

(54) Fibrous structures comprising a design and processes for making same

(76) Inventors: John Allen Manifold, Milan, IN (US); Thorsten Knobloch, Loveland, OH (US); Douglas Jay Barkey, Maineville, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/242,586

(22) Filed: Oct. 3, 2005

Related U.S. Application Data
(60) Provisional application No. 60/621,096, filed on Oct. 22, 2004.

(51) Int. Cl. B32B 1/00

(52) U.S. Cl. 428/174

(57) ABSTRACT

Fibrous structures and/or sanitary tissue products comprising such fibrous structures, wherein the fibrous structures comprise a design, particularly a surface design, and processes for making such fibrous structures and/or sanitary tissue products are provided.

### CROSS REFERENCE TO RELATED APPLICATION

This application claims the benefit of U.S. Provisional Application No. 60/621,096 filed on Oct. 22, 2004.

### FIELD OF THE INVENTION

The present invention relates to fibrous structures and/or sanitary tissue products comprising such fibrous structures, wherein the fibrous structures comprise a design, particularly a surface design, and processes for making such fibrous structures and/or sanitary tissue products.

### BACKGROUND OF THE INVENTION

Fibrous structures comprising a design, particularly a surface design, are known.

Conventionally, there are multiple approaches for imparting a design to fibrous structures. One approach is by embossing the fibrous structure to impart a design. Typically, embossing is either performed by an apparatus directed to well known processes such as nested embossing, knob-to-knob embossing, steel to rubber embossing and/or steel to steel embossing. Embossing is a post-fibrous structure making process and occurs when the fibrous structure is dry. Fibrous structures that are embossed to impart a design thereto typically have discrete embossments that protrude from the fibrous structure. These embossments may be grouped together to form a design or pattern. One issue with imparting designs to fibrous structures by embossing is that the embossed designs are not water stable unless the embossed designs are subjected to some additional process, such as chemical treatment. In other words, when an emboss design is saturated with water, the embossments relax and disappear or substantially disappear from the fibrous structure. This results from the fact that embossing process disrupts bonds between fibers in the fibrous structure. This disruption occurs because the bonds are formed and set upon drying of the embryonic fibrous slurry used to make the fibrous structure. When water is applied to the embossments, the fibrous structure at the embossments, which do not contain bonds between fibers, relaxes.

Another approach for imparting a design to fibrous structures is by imparting the design into the fibrous structure during the fibrous structure making process. In one example, a design is created in a resin that is deposited on a fabric or a belt. The resin/fabric combination is oftentimes referred to as a deflection member because the resin is typically a continuous network that contains openings (recesses) into which fibers of the fibrous structure may be deflected. The designs created by this process are conventionally referred to as micropatterns since they impart a pattern that encompasses the entire fibrous structure. However, some larger designs, called “macropatterns”, which do not encompass the entire fibrous structure may be created by this process. To date, these macropatterns, such as roses, have included linear elements that are grouped together with other linear elements to form the macropattern. Unlike designs made by embossing, designs imparted to fibrous structures during the making of the fibrous structure resist relaxation upon contact with water because the bonds between fibers that formed during the fibrous structure making process within such designs are still intact.

Imparting patterns, especially macropatterns that comprise linear elements, into fibrous structures during the making of the fibrous structures may result in cumbersome deflection of fibers into the linear element areas, which may result in more pinholing in the fibrous structures made by such process. Further, since conventional linear elements used in such processes typically have sharper corners and/or edges and more of them than other non-linear elements, the fibers within the linear elements may be less efficiently dried.

In light of the issues with imparting designs and/or patterns to fibrous structures described above, there is a need for a fibrous structure that comprises a design, especially a macropattern design, that exhibits an appearance of an embossment, wherein the design exhibits properties similar and/or better than the properties of a design that has been imparted to the fibrous structure during making of the fibrous structure.

Accordingly, there is a need for a fibrous structure and/or sanitary tissue product comprising a design and processes for making such fibrous structures and/or sanitary tissue products.

### SUMMARY OF THE INVENTION

The present invention fulfills the needs described above by providing a fibrous structure and/or sanitary tissue product that comprises a design and processes for making such fibrous structures and/or sanitary tissue products.

In one example of the present invention, a fibrous structure comprising a surface and a design wherein the design comprises a plurality of discrete, non-linear design elements, wherein the discrete, non-linear design elements are spatially associated with one another such that the plurality of discrete, non-linear design elements visually represent a linear design element within the design and wherein the design encompasses less than the entire surface area (for example, less than 50% and/or less than 40% and/or less than 30% and/or less than 25% and/or less than 15% and/or less than 10%) of the surface of the fibrous structure, is provided. In other words, the design does not touch each and every peripheral edge of the surface of the fibrous structure.

In another example of the present invention, a fibrous structure comprising:

a. a network region;

b. a first dome region comprising at least one dome;

c. a second dome region comprising three or more domes,

wherein a different Value for an intensive property exists between the network region and the first dome region and/or the network region and the second dome region and/or the first dome region and the second dome region, is provided.

In still another example of the present invention, a fibrous structure comprising a design, wherein the design comprises at least three discrete, non-linear design elements spatially arranged to visually represent a linear design element wherein at least one of the at least three discrete, non-linear design elements consists of two visually discernible regions, is provided.

In even still another example of the present invention, a fibrous structure comprising a surface and a design wherein the design comprises at least one and/or at least two and/or at least three discrete, non-linear design elements, wherein at least one of the discrete, non-linear design elements remains after the design element has been contacted by water (for example saturated by water), wherein the design encompasses less than the entire surface area of the surface of the fibrous structure, is provided.

In yet another example of the present invention, a method for making a fibrous structure comprising the step of forming a fibrous structure comprising a design comprising at least three discrete, non-linear design elements spatially arranged to visually represent a linear design element, is provided.

Accordingly, the present invention provides a fibrous structure and/or sanitary tissue product comprising such fibrous structure, wherein the fibrous structure comprises a design and processes for making such fibrous structure.

### BRIEF DESCRIPTION OF THE DRAWINGS

FIG. 1 is a plan view of one example of a fibrous structure in accordance with the present invention;

FIG. 2 is a cross sectional view of the fibrous structure shown in FIG. 1 taken along line 2-2;

FIG. 3 is a plan view of another example of a fibrous structure in accordance with the present invention;

FIG. 4 is a cross sectional view of the fibrous structure shown in FIG. 3 taken along line 4-4;

FIG. 5 is a plan view of another example of a fibrous structure in accordance with the present invention;

FIG. 6 is a cross sectional view of the fibrous structure shown in FIG. 5 taken along line 6-6;

FIG. 7 is a plan view of another example of a fibrous structure in accordance with the present invention;

FIG. 8 is a cross sectional view of the fibrous structure shown in FIG. 7 taken along line 8-8;

FIG. 9 is a schematic representation of one example of a fibrous structure making machine useful in the practice of the present invention;

FIG. 10 is a plan view of a portion of deflection member useful in the practice of the present invention; and

FIG. 11 is a cross sectional view of the deflection member shown in FIG. 10 taken along line 11-11.

### DETAILED DESCRIPTION OF THE INVENTION

Definitions

“Fibrous structure” and/or “Web” as used herein means a substrate formed from non-woven fibers. The fibrous structure of the present invention may be made by any suitable process, such as wet-laid, air-laid, spunbond processes. The fibrous structure may be in the form of one or more plies suitable for incorporation into a sanitary tissue product and/or may be in the form of non-woven garments, such as surgical garments including surgical shoe covers, and/or non-woven paper products such as surgical towels and wipes.

An embryonic fibrous web can be typically prepared from an aqueous dispersion of fibers, though dispersions in liquids other than water can be used. Such a liquid dispersion of fibers is oftentimes called a fibrous slurry. The fibers can be dispersed in the carrier liquid to have a consistency of from about 0.1% to about 0.3%. It is believed that the present invention can also be applicable to moist forming operations where the fibers are dispersed in a carrier liquid to have a consistency less than about 50%, more preferably less than about 10%.

Alternatively, an embryonic fibrous web can be prepared using air laid technology wherein a composition of fibers, (not typically dispersed in a liquid) are deposited onto a surface, such as a forming member, such that an embryonic web is formed.

The fibrous structures of the present invention may have physical properties, such as dry tensile strength, wet tensile strength, caliper, basis weight, density, opacity, wet burst, decay rate, softness, bulk, lint and sidedness suitable to consumers for fibrous structures used in sanitary tissue products and/or known by those skilled in the art to be suitable for fibrous structures used in sanitary tissue products.

“Fiber” as used herein means an elongate particulate having an apparent length greatly exceeding its apparent width, i.e. a length to diameter ratio of at least about 10. More specifically, as used herein, “fiber” refers to papermaking fibers. The present invention contemplates the use of a variety of papermaking fibers, such as, for example, natural fibers or synthetic fibers, or any other suitable fibers, and any combination thereof. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking. In addition to the above, fibers and/or filaments made from polymers, specifically hydroxyl polymers may be used in the present invention. Nonlimiting examples of suitable hydroxyl polymers include polyvinyl alcohol, starch, starch derivatives, chitosan, chitosan derivatives, cellulose derivatives, gums, arabinans, galactans and mixtures thereof.

“Fibrous furnish” as used herein means a composition of fibers. In one example, the fibrous furnish may comprise fibers and a liquid, such as water.

“Sanitary tissue product” as used herein means a single- or multi-ply wiping implement for post-urinary and post-bowel movement cleaning (toilet tissue), for otorhinolaryngological discharges (facial tissue), and multi-functional absorbent and cleaning uses (absorbent towels).

The sanitary tissue products of the present invention may have physical properties, such as dry tensile strength, wet tensile strength, caliper, basis weight, density, opacity, wet burst, decay rate, softness, bulk, lint and sidedness suitable to consumers for use as sanitary tissue products and/or known by those skilled in the art to be suitable for use as sanitary tissue products.

“Ply” or “Plies” as used herein means an individual fibrous structure optionally to be disposed in a substantially contiguous, face-to-face relationship with other plies, forming a multiple ply fibrous structure. It is also contemplated that a single fibrous structure can effectively form two “plies” or multiple “plies”, for example, by being folded on itself.

The fibrous structure and/or sanitary tissue product of the invention may be a single ply web or may be one ply or a multi-ply structure. A multi-ply fibrous structure may be comprised of multiple plies of a fibrous structure of the present invention or of a combination of a plies, at least one of which is a fibrous structure ply of the present invention.

“Basis Weight” as used herein is the weight per unit area of a sample reported in lbs/3000 ft² or g/m². Basis weight is measured by preparing one or more samples of a certain area (m²) and weighing the sample(s) of a fibrous structure according to the present invention and/or a paper product comprising such fibrous structure on a top loading balance with a minimum resolution of 0.01 g. The balance is protected from air drafts and other disturbances using a draft shield. Weights are recorded when the readings on the balance become constant. The average weight (g) is calculated and the average area of the samples (m²). The basis weight (g/m²) is calculated by dividing the average weight (g) by the average area of the samples (m²). If needed, the basis weight in g/m² units can be converted to lbs/3000 ft².

“Caliper” as used herein means the macroscopic thickness of a sample. Caliper of a sample of fibrous structure according to the present invention is determined by cutting a sample of the fibrous structure such that it is larger in size than a load foot loading surface where the load foot loading surface has a circular surface area of about 3.14 in². The sample is confined between a horizontal flat surface and the load foot loading surface. The load foot loading surface applies a confining pressure to the sample of 15.5 g/cm² (about 0.21 psi). The caliper is the resulting gap between the flat surface and the load foot loading surface. Such measurements can be obtained on a VIR Electronic Thickness Tester Model II available from Thwing-Albert Instrument Company, Philadelphia, Pa. The caliper measurement is repeated and recorded at least five (5) times so that an average caliper can be calculated. The result is reported in millimeters.

The caliper of the web is typically measured under a pressure of 95 grams per square inch using a round presser foot having a diameter of 2 inches, after a dwell time of 3 seconds. The caliper can be measured using a Thwing-Albert Thickness Tester Model 89-100, manufactured by the Thwing-Albert Instrument Company of Philadelphia, Pa. The caliper is measured under TAPPI temperature and humidity conditions.

“Density” as used herein means the basis weight of a sample divided by the caliper with appropriate conversions incorporated therein. Apparent density used herein has the units g/cm³.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121. Unless otherwise specified, all molecular weight values herein refer to the weight average molecular weight.

“Machine Direction” or “MD” as used herein means the direction parallel to the flow of the fibrous structure through the fibrous structure making machine and/or product manufacturing equipment.

“Cross Machine Direction” or “CD” as used herein means the direction perpendicular to the machine direction in the same plane of the fibrous structure and/or sanitary tissue product comprising the fibrous structure.

“Circumscribe” as used herein means that a first region is disposed substantially within a second region. Thus, it is not necessary that the first region be closed or wholly contained in the second region to consider the first region to be circumscribed by the second region or to consider the first region to be substantially within the second region.

“Non-linear” as used herein means that an object, such as a design element, exhibits a shape or a visual configuration that is different from a line. For example, an object, such as a design element, that exhibits a ratio of greatest geometric dimension to minimum geometric dimension (often referred to as an aspect ratio) of less than about 50:1 and/or less than about 30:1 and/or less than about 15:1 and/or less than about 10:1 and/or less than about 5:1 and/or less than about 2:1 and/or about 1:1.

“Intensive Property” and/or “Intensive Properties” and/or “Values of Common Intensive Property” and/or “Values of Common Intensive Properties” as used herein means density, basis weight, caliper, substrate thickness, elevation, opacity, crepe frequency, tensile strength and any combination thereof. The fibrous structures of the present invention may comprise two or more regions that exhibit different values of common intensive properties relative to each other. In other words, a fibrous structure of the present invention may comprise one region having a first opacity value and a second region having a second opacity value different from the first opacity value. Such regions may be continuous, substantially continuous and/or discontinuous.

Fibrous Structure

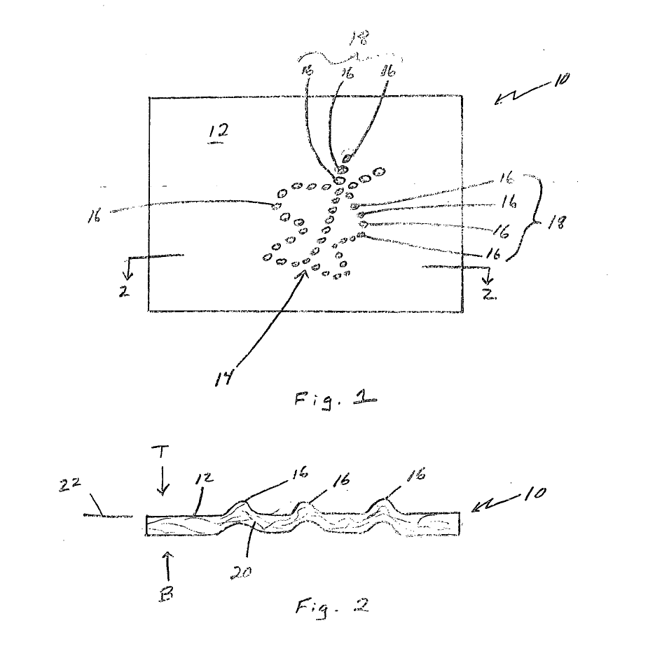

In one example, a fibrous structure 10 according to the present invention, as shown in FIG. 1, comprises a surface 12 and a design 14 wherein the design 14 comprises a plurality of discrete, non-linear design elements 16, wherein the discrete, non-linear design elements 16 are spatially associated with one another such that the plurality of discrete, non-linear design elements 16 visually represent a linear design element 18 within the design 14 and wherein the design 14 encompasses less than the entire surface area of the surface 12 of the fibrous structure 10.

A representative cross section of the fibrous structure 10 taken along line 2-2 is represented in FIG. 2. FIG. 2 shows the fibrous structure 10 and a plurality of discrete, non-linear design elements 16. The fibrous structure 10 comprises at least one fiber 20. A plurality of fibers 20 are shown in the example of the fibrous structure 10. As shown in FIGS. 1 and 2, the discrete, non-linear design elements 16 may be domes.

As shown in FIG. 2, the discrete, non-linear design elements 16 appear to extend from (protrude from) a plane 22 of the fibrous structure 10 toward an imaginary observer looking in the direction of arrow T. When viewed by an imaginary observer looking in the direction indicated by arrow B, the discrete, non-linear design elements 16 appear to be cavities or dimples. The portions of the fibrous structure 10 forming the discrete, non-linear design elements 16 can be intact; however, the portions of the fibrous structure 10 forming the discrete, non-linear design elements 16 can comprise one or more holes or openings extending essentially through the fibrous structure 10.

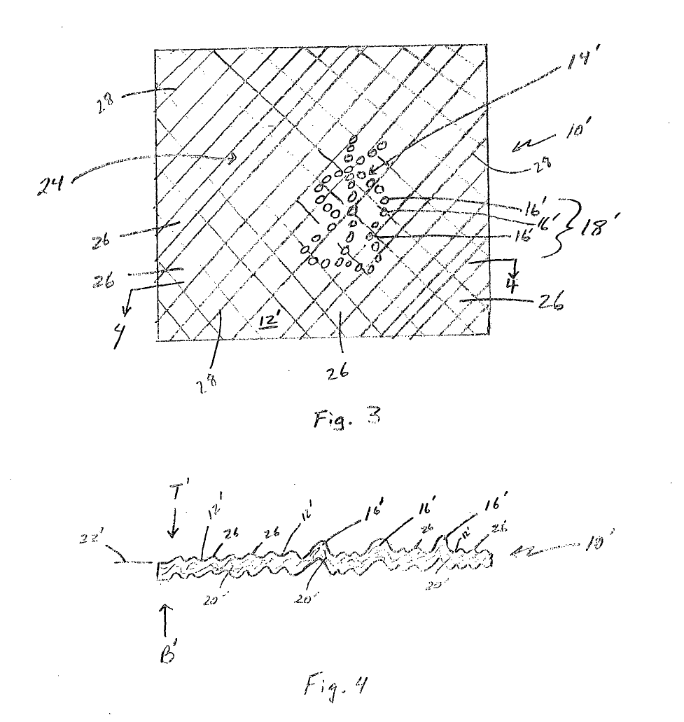

As shown in FIG. 3, another example of a fibrous structure 10′ according to the present invention comprises a surface 12′ and a first design 14′ and a second design 24, wherein the first design 14′ comprises a plurality of discrete, non-linear design elements 16′, wherein the discrete, non-linear design elements 16′ are spatially associated with one another such that the plurality of discrete, non-linear design elements 16′ visually represent a linear design element 18′ within the first design 14′ and wherein the first design 14′ encompasses less than the entire surface area of the surface 12′ of the fibrous structure 10′. Further, the second design 24 encompasses the entire surface area of the surface 12′ and even a portion of that is encompassed by the first design 14′. In one example, visually, the second design 24 appears to be present on the entire surface area of the surface 12′ of the fibrous structure 10′ except in those areas where the first design 14′ is present. The second design 24 may comprise discrete, design elements 26 that when spatially associated with one another visually form a design. In this example, the second design 24 may be referred to as a “micropattern” and the first design 14′ may be referred to as a “macropattern.”

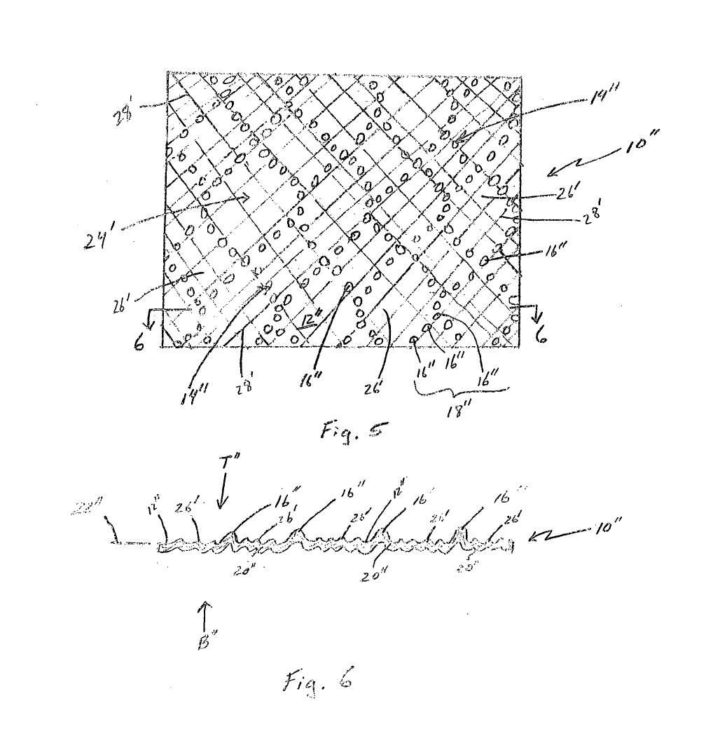

A representative cross section of the fibrous structure 10′ taken along line 4-4 is represented in FIG. 4. FIG. 4 shows the fibrous structure 10′ and a plurality of discrete, non-linear design elements 16′ and a plurality of discrete design elements 26. The fibrous structure 10′ comprises at least one fiber 20′. A plurality of fibers 20′ are shown in the example of the fibrous structure 10′. As shown in FIGS. 3 and 4, the discrete, non-linear design elements 16′ and/or discrete design elements 26 may be domes.

As shown in FIG. 4, the discrete, non-linear design elements 16′ and/or discrete design elements 26 appear to extend from (protrude from) a plane 22′ of the fibrous structure 10′ toward an imaginary observer looking in the direction of arrow T′. When viewed by an imaginary observer looking in the direction indicated by arrow B′, the discrete, non-linear design elements 16′ and/or discrete design elements 26 appear to be cavities or dimples. The portions of the fibrous structure 10′ forming the discrete, non-linear design elements 16′ and/or discrete design elements 26 can be intact; however, the portions of the fibrous structure 10′ forming the discrete, non-linear design elements 16′ and/or the discrete design elements 26 can comprise one or more holes or openings extending essentially through the fibrous structure 10′.

As shown in FIG. 5, another example of a fibrous structure 10″ according to the present invention comprises a surface 12″ and a first design 14″ and a second design 24′, wherein the first design 14″ comprises a plurality of discrete, non-linear design elements 16″, wherein the discrete, non-linear design elements 16″ are spatially associated with one another such that the plurality of discrete, non-linear design elements 16″ visually represent a linear design element 18″ within the first design 14″ and wherein the first design 14″ encompasses less than the entire surface area of the surface 12″ of the fibrous structure 10″. Further, the second design 24′ encompasses the entire surface area of the surface 12″ and even a portion of that is encompassed by the first design 14″. In one example, visually, the second design 24′ appears to be present on the entire surface area of the surface 12″ of the fibrous structure 10″ except in those areas where the first design 14″ is present. The second design 24′ may comprise discrete, design elements 26′ that when spatially associated with one another visually form a design. In this example, the second design 24′ may be referred to as a “micropattern” and the first design 14″ may be referred to as a “macropattern.”

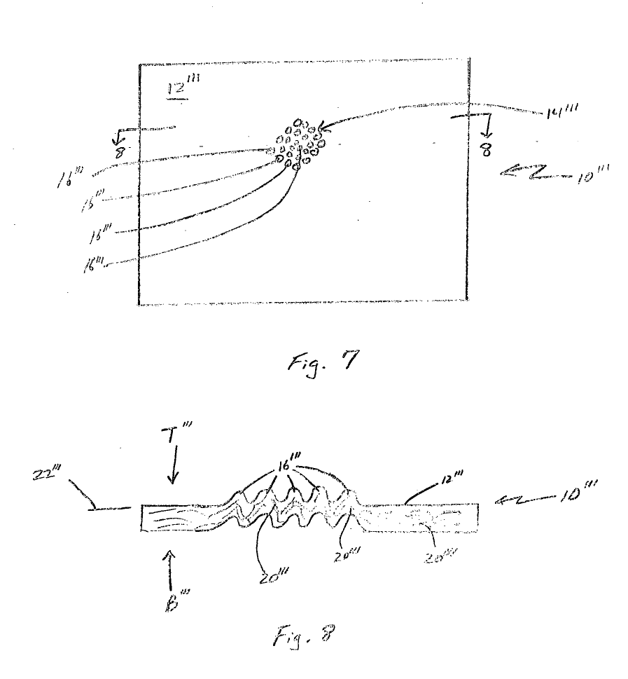

A representative cross section of the fibrous structure 10″ taken along line 5-5 is represented in FIG. 6. FIG. 6 shows the fibrous structure 10″ and a plurality of discrete, non-linear design elements 16″ and a plurality of discrete design elements 26′. The fibrous structure 10″ comprises at least one fiber 20″. A plurality of fibers 20″ are shown in the example of the fibrous structure 10″. As shown in FIGS. 5 and 6, the discrete, non-linear design elements 16″ and/or discrete design elements 26′ may be domes.

As shown in FIG. 6, the discrete, non-linear design elements 16″ and/or discrete design elements 26′ appear to extend from (protrude from) a plane 22″ of the fibrous structure 10″ toward an imaginary observer looking in the direction of arrow T″. When viewed by an imaginary observer looking in the direction indicated by arrow B″, the discrete, non-linear design elements 16″ and/or discrete design elements 26′ appear to be cavities or dimples. The portions of the fibrous structure 10″ forming the discrete, non-linear design elements 16″ and/or discrete design elements 26′ can be intact; however, the portions of the fibrous structure 10″ forming the discrete, non-linear design elements 16″ and/or the discrete design elements 26′ can comprise one or more holes or openings extending essentially through the fibrous structure 10″.

In the fibrous structures of the present invention, at least one of the discrete, non-linear design elements and/or discrete design elements, may at least retain at least one of its dry properties such as its structural shape, height, opacity and the like after being wetted, such as after being saturated with water. For example, the discrete, non-linear design element may retain at least 10% and/or 20% and/or 30% and/or 40% and/or 50% and/or 60% of its dry structural height as measured according to the Dry-Wet Structural Height Test Method described herein. In one example, the discrete, non-linear design element retains at least about 100% (even adding structural height to be greater than the dry height of the discrete, non-linear design element) of its dry structural height as measured according to the Dry-Wet Structural Height Test Method described herein.

In addition to a plurality of discrete, non-linear design elements being spatially associated with one another such that the plurality of discrete, non-linear design elements visually represent (form) a linear design element within a design, the discrete, non-linear design elements may be spatially associated with one another such that the plurality of discrete, non-linear design elements visually represent (form) a discrete object or shape, such as a diamond, circle, square, rectangle, ellipse and/or outlines of such shapes.

FIG. 7 shows another example of a fibrous structure 10′″ of the present invention wherein the fibrous structure 10′″ comprises a surface 12′″ and a design 14′″ wherein the design 14′″ comprises a plurality of discrete, non-linear design elements 16′″, wherein the discrete, non-linear design elements 16′″ are spatially associated with one another such that the plurality of discrete, non-linear design elements 16′″ visually represent a discrete object or shape, in this case a diamond. The design 14′″ encompasses less than the entire surface area of the surface 12′″ of the fibrous structure 10′″.

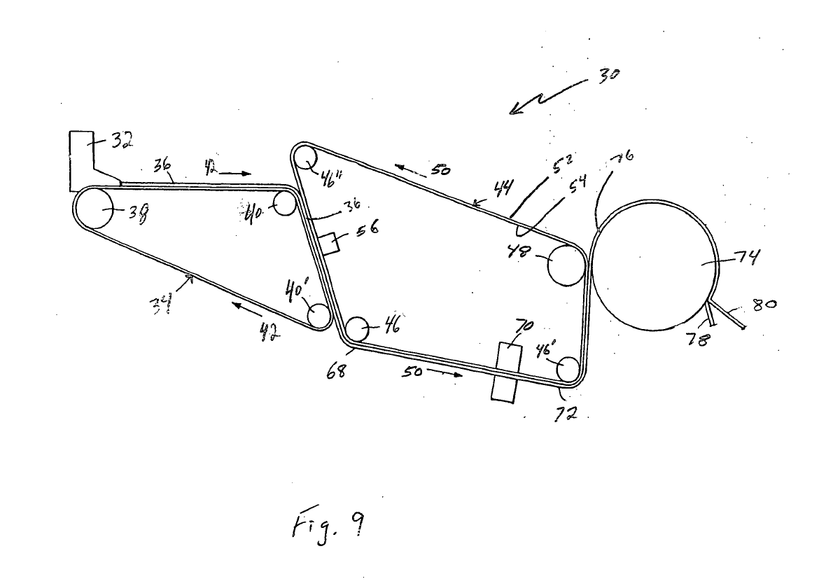

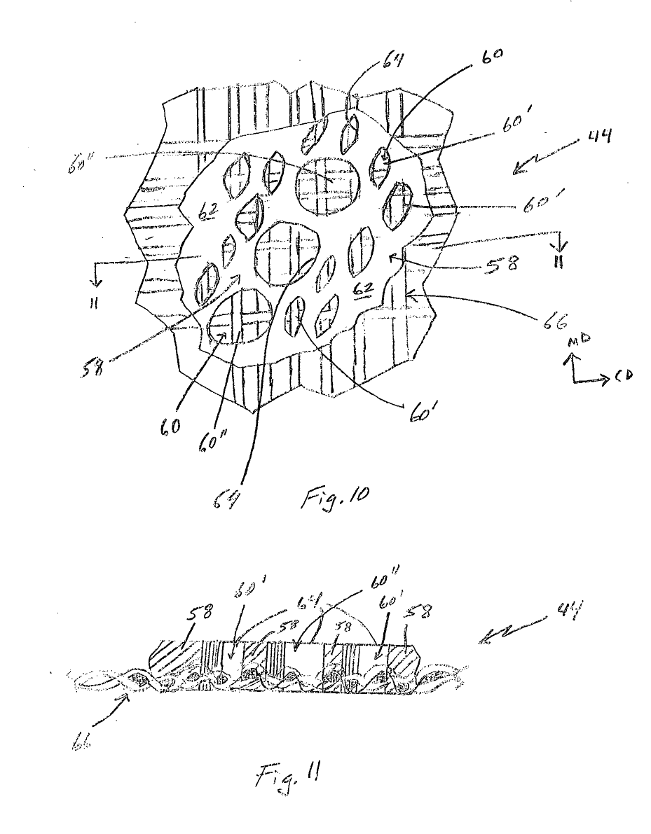

A representative cross section of the fibrous structure 10′″ taken along line 8-8 is represented in FIG. 8. FIG. 8 shows the fibrous structure 10′″ and a plurality of discrete, non-linear design elements 16′″. The fibrous structure 10′″ comprises at least one fiber 20′″. A plurality of fibers 20′″ are shown in the example of the fibrous structure 10′″. As shown in FIGS. 7 and 8, the discrete, non-linear design elements 16′″ may be domes.

As shown in FIG. 8, the discrete, non-linear design elements 16′″ appear to extend from (protrude from) a plane 22′″ of the fibrous structure 10′″ toward an imaginary observer looking in the direction of arrow T′″. When viewed by an imaginary observer looking in the direction indicated by arrow B′″, the discrete, non-linear design elements 16′″ appear to be cavities or dimples. The portions of the fibrous structure 10′″ forming the discrete, non-linear design elements 16′″ can be intact; however, the portions of the fibrous structure 10′″ forming the discrete, non-linear design elements 16′″ can comprise one or more holes or openings extending essentially through the fibrous structure 10′″.

The discrete, non-linear design elements and the discrete design elements present in the fibrous structures of the present invention may have different properties, such as different sizes, different structural heights, different frequencies, different densities (how many elements are within a certain surface area), different aspect ratios, different shapes, and the like, such that the elements are visually discernible from one another.

In one example of a fibrous structure in accordance with the present invention, the discrete, non-linear design elements may exhibit a dry and/or a wet structural height of at least about 100 μm and/or at least about 150 μm and/or at least about 200 μm and/or at least about 250 μm and/or at least about 300 μm and/or at least about 400 μm and/or at least about 500 μm and/or at least about 600 μm.

In another example of a fibrous structure in accordance with the present invention, the discrete design elements may exhibit a dry and/or a wet structural height of less than about 5000 μm and/or less than about 4000 μm and/or less than about 3500 μm.

In one example, at least one discrete, non-linear design element within the fibrous structure exhibits a ratio of wet structural height to dry structural height of at least 0.3 and/or at least about 0.4 and/or at least about 0.5 and/or at least about 0.6 and/or at least about 0.7.

Even though FIGS. 7 and 8 do not illustrate discrete design elements like FIGS. 3-6, such discrete design elements may be included in the fibrous structure illustrated in FIGS. 7 and 8.

As shown in FIGS. 3-6, a fibrous structure in accordance with the present invention may comprise at least two dome regions. A first dome region comprising discrete design elements 26, 26′ and a second dome region comprising discrete, non-linear design elements 16′, 16″.

As shown in FIGS. 3 and 5, the surface 12′, 12″ may comprise a surface network 28, 28′. The surface network 28, 28′ may form an essentially continuous, essentially macroscopically monoplanar network region. The surface network 28, 28′ can be continuous. It can be macroscopically monoplanar, and can form a preselected pattern. When two or more dome regions, for example 26 and 16′ are present in the fibrous structure along with a network region, the network region may completely encircle at least one dome 26 from the first dome region and/or one dome 16′ from the second dome region. The network region may isolate one dome from another dome. The domes can be dispersed throughout the whole of the network region. The network region may have a relatively low basis weight and/or a relative high density while the domes may have relatively high basis weights and/or relatively low densities. Further, the domes may exhibit relatively low intrinsic strength while the network region may exhibit relatively high intrinsic strength.

The density of the network region may be from about 0.400 g/cm³ to about 0.800 g/cm³ and/or from about 0.500 g/cm³ to about 0.700 g/cm³. The average density of the domes may be preferably from about 0.040 g/cm³ to about 0.150 g/cm³ and/or from about 0.060 g/cm³ to about 0.100 g/cm³. Considering the number of fibers underlying a unit area projected onto the portion of the fibrous structure under consideration, the ratio of the basis weight of the network region to the average basis weight of the domes is from about 0.8 to about 1.0.

The surface network can be referred to as a “network region” because it comprises a system of lines of essentially uniform physical characteristics which intersect, interlace, and/or cross like the fabric of a net. The network region may be described as “continuous” because the lines of the network region may be essentially uninterrupted across the surface of the fibrous structure. (Naturally, because of its very nature fibrous structures of the present invention may never be completely uniform, e.g., on a microscopic scale. The lines of essentially uniform characteristics are uniform in a practical sense and, likewise, uninterrupted in a practical sense). The network region may be described as “macroscopically monoplanar” because, when the fibrous structure as a whole is placed in a planar configuration, the top surface (i.e. the surface lying on the same side of the fibrous structure as the protrusions of the domes) of the network region is essentially planar. (The preceding comments about microscopic deviations from uniformity within a fibrous structure apply here as well as above.). The network region may be described as forming a preselected pattern because the lines define (or outline) a specific shape (or shapes) in a repeating (as opposed to random) pattern. However, a random pattern may also result from the lines of the network region.

In one example of the present invention, at least one dome of the first dome region is encompassed by the network region. In another example of the present invention, the first dome region comprises a plurality of domes. In another example of the present invention, three or more domes of the second dome region form a design element of a design. In another example of the present invention, two or more of the network region and one or more dome regions exhibit different values for an intensive property than another of the regions. In another example of the present invention, one or more dome regions are adjacent to the network region. In another example of the present invention, at least one dome of the first dome region and at least one dome of the at least three domes of the second dome region are separated from one another by the network region. In another example of the present invention, the network region exhibits a basis weight that is lower than the basis weight of one or more of the dome regions. In another example of the present invention, the network region exhibits a density that is higher than the density of one or more of the dome regions. In another example of the present invention, the network region exhibits an elevation that is less than the elevation of the at least one dome of the one or more dome regions. In another example of the present invention, at least one dome of the first dome region exhibits an elevation that is less than the elevation of at least one of the at least three domes of the second dome region.

In another example of the present invention, the first dome region consists of a plurality of domes and the second dome region consists of a plurality of domes wherein each of the domes of the plurality of domes of the second dome region exhibits an elevation that is greater than the elevation of each of the domes of the plurality of domes of the first dome region. In another example of the present invention, at least one dome of the at least three domes of the second dome region exhibits a greatest minimum that is greater than the greatest dimension of at least one dome of the first dome region. In another example of the present invention, the first dome region consists of a plurality of domes and the second dome region consists of a plurality of domes wherein each of the domes of the plurality of domes of the second dome region exhibits a minimum dimension that is greater the greatest dimension of each of the domes of the plurality of domes of the first dome region.

As shown in FIGS. 1, 3, 5 and 7, a fibrous structure 10, 10′, 10″, 10′″ in accordance with the present invention may comprise a design 14, 14′, 14″, 14′″ wherein the design 14, 14′, 14″, 14′″ comprises at least three discrete, non-linear design elements 16, 16′, 16″, 16′″ spatially arranged to visually represent a linear design element 18, 18′, 18″ and/or visually represent a discrete object, wherein at least one of the at least three discrete, non-linear design elements 16, 16′, 16″, 16′″ comprises at least two and/or at least three and/or at least four visually discernible regions. In one example of a fibrous structure of the present invention, at least one of the at least three discrete, non-linear design elements consists of two visually discernible regions.

The fibrous structure may comprise a background matrix represented by the second design 24, 24′ in FIGS. 3 and 5. At least one of the at least three discrete, non-linear design elements 16′, 16″ may be superimposed on the background matrix. The background matrix may be adjacent to at least one of the at least three discrete, non-linear design elements 16′, 16″. The background matrix may visually represent (form) one of the two visually discernible regions of the fibrous structure.

In one example of a fibrous structure of the present invention, one of the two visually discernible regions may circumscribe the other visually discernible region. In another example of a fibrous structure of the present invention, one of the two visually discernible regions may exhibit a first value of an optically intensive property and the other of the two visually discernible regions may exhibit a second value of the optically intensive property, wherein the first value and second value are different. The difference between the first value of an optically intensive property and the second value of the optically intensive property may be at least about 5% and/or at least about 10% and/or at least about 15% and/or at least about 30% and/or at least about 50%. In one example of the present invention, the two visually discernible regions differ in elevation by at least about 100 μm and/or at least about 125 μm and/or at least about 150 μm and/or at least about 200 μm.

While, of course, the visual discernibility of the pattern and the visual distinguishability of the regions may be dependent upon the acuity of the eyesight of the consumer, the visually discernible regions of the fibrous structure can be distinguished from one another by the value of any one of three optically intensive properties. As used herein, “optically intensive properties” are three specified properties which do not change in value upon the aggregation of fibers to the fibrous structure within the plane of the fibrous structure or upon aggregating a foreign substance, such as ink, with the fibrous structure. The three specified properties are crepe frequency, elevation and opacity. Thus, patterns formed by contrasting colors are not considered to be formed by optically intensive properties.

Moreover, the visually discernible regions of the at least one of the three discrete, non-linear design elements may be disposed in patterns, as set forth below, which are large enough to be discerned by a consumer and distinguished from a background matrix of the fibrous structure. The relatively large size of the pattern enhances consumer understanding that the purpose of the pattern is to impart an aesthetically pleasing appearance to the fibrous structure and thereby make the fibrous structure and/or sanitary tissue product comprising such fibrous structure more desirable to the consumer.

One value of an optically intensive property which may be used to distinguish one visually discernible region from another visually discernible region is the value of the crepe frequency of that each region. The crepe frequency is defined as the number of times a peak occurs on the surface of the fibrous structure for a given linear distance. More particularly, “crepe frequency” is defined as the number of cycles per millimeter (cycles per inch) of the visually discernible region. These cycles are associated with chatter of the aforementioned doctor blade during the creping operation.

The crepe frequency is closely associated with the amplitude of the undulations which form the cycles. The crepe frequency is generally not the same as the frequency of the visually discernible regions forming the design (pattern) of the surface topography of the fibrous structure.

It is to be recognized that the value of the crepe frequency may not be constant throughout a given visually discernible region. Therefore, it is important to measure a large enough distance or combination of distances throughout a particular visually discernible region so that the value of a particular crepe frequency may be found.

Furthermore, if one examines any background matrix present in the fibrous structure, at least two values of crepe frequencies may be present. This may occur, for example, if the background matrix is made on a conventional forming wire and dried on a belt having a particular background matrix or, alternatively, is made on a forming wire having a particular background matrix thereon.

If the background matrix is comprised of more than one value of crepe frequency, as opposed to normal and expected variations within the same crepe frequency, the crepe frequency of the background matrix is considered to be the lower or lowest frequency of the plurality of individual crepe frequencies present. Of course, the background matrix, as described above, may comprise the majority of the surface area of the fibrous structure.

For two visually discernible regions to be mutually visually distinguishable based on crepe frequency differences (and the design (pattern) to be visually discernible), the value of crepe frequencies between adjacent visually discernible regions may vary by at least about 2 cycles per millimeter (51 cycles per inch) and/or by at least about 5 cycles per millimeter (130 cycles per inch).

In one example of a fibrous structure according to the present invention, the crepe frequency of the background matrix, if any, may be about 0.87 cycles per millimeter (20.0 cycles per inch). The crepe frequency of one of the visually discernible regions may be about 7 to about 8 cycles per millimeter (180 to 200 cycles per inch). The crepe frequency of the other visually discernible region may be about 2 cycles per millimeter (50 cycles per inch).

A value of a second optically intensive property which may be used to distinguished one visually discernible region from another visually discernible region is the opacity of that visually discernible region. “Opacity” is the property of a fibrous structure which prevents or reduces light transmission therethrough. Opacity is directly related to the basis weight and uniformity of fiber distribution of the fibrous structure and is also influenced by the density of the fibrous structure. A fibrous structure having a relatively greater basis weight or uniformity of fiber distribution will also have a greater opacity for a given density.

As used herein, the “basis weight” of a visually discernible region is the weight, measured in grams force, of a unit area of that visually discernible region of the fibrous structure, which unit area is taken in the plane of the fibrous structure. The size and shape of the unit area from which the basis weight is measured is dependent upon the relative and absolute sizes and shapes of the visually discernible regions forming the background matrix, if any, and design (pattern) of the fibrous structure under consideration. The “density” of a visually discernible region is the basis weight of such a visually discernible region divided by its thickness.

It will be recognized by one skilled in the art that within a given visually discernible region, ordinary and expected basis weight fluctuations and variations may occur, when a given visually discernible region is considered to have a basis weight of one particular value. For example, if on a microscopic level, the basis weight of an interstice between fibers is measured, an apparent basis weight of zero will result when, in fact, unless an aperture in the fibrous structure is being measured the basis weight of such visually discernible region is greater than zero. Such fluctuations and variations are normal and expected part of the fibrous structure manufacturing process.

It is not necessary a perfect or razor sharp demarcation between adjacent visually discernible regions of different basis weights be apparent. It is only important that the distribution of fibers per unit area be different in adjacent visually discernible regions and that such visually discernible regions occur in a visually discernible pattern. The different basis weights of the visually discernible regions provide for different opacities of such visually discernible regions.

Increasing the density of a visually discernible region having a particular basis weight will increase the opacity of such visually discernible region up to a point. Beyond this point, further densification of a visually discernible region having a particular basis weight will decrease opacity. Thus, two visually discernible regions of the same basis weights may have different opacities, depending upon the relative densification of such visually discernible regions. Alternatively, two visually discernible regions of the same opacity may have different basis weights and not otherwise be visually distinguishable to the consumer.

For two visually discernible regions to be mutually visually distinguishable based on opacity differences (and the design (pattern) to be visually discernible), the value of opacities between adjacent visually discernible regions may vary by at least about 20 grey levels.

The third optically intensive property value which may be utilized to distinguish one visually discernible region from another visually discernible region is the elevation (structural height) of such visually discernible regions. As used herein the “elevation” is the distance, taken normal to the plane of the fibrous structure, of a visually discernible region as measured from the planar surface of the fibrous structure when it is viewed from the face not in contact with the drying belt. A visually discernible region may vary in elevation from the planar surface of the fibrous structure in either direction normal to the plane of the fibrous structure. The elevational differences create shadows and highlights in adjacent visually discernible regions causing the design (pattern) to be visually discernible.

For two visually discernible regions to be mutually visually distinguishable based on elevation differences (and the design (pattern) to be visually discernible), the value of elevations between adjacent visually discernible regions may vary by at least about 0.05 millimeters (0.002 inches) and/or at least about 0.08 millimeters (0.003 inches) to about 0.38 millimeters (0.015 inches) and/or to about 0.23 millimeters (0.009 inches).

Thus, two adjacent visually discernible regions may be visually discernible if the values of one, two or three of the optically intensive properties of such visually discernible regions are different.

Of the three aforementioned optically intensive properties, the value of the elevation may be the most critical in producing a visually discernible pattern. Thus, the elevation difference may be used alone, or in conjunction with either of the other two optically intensive properties to produce the desired pattern. Of course, the value of the elevation difference should increase if this property is not used in conjunction with opacity and crepe frequency to produce the desired pattern.

In one example of a fibrous structure according to the present invention, the two visually discernible regions differ in elevation (structural height) by at least about 100 μm and/or at least about 150 μm and/or at least about 200 μm and/or at least about 250 μm.

In another example of a fibrous structure according to the present invention, one of the two visually discernible regions may exhibit a first value of density and the other of the two visually discernible regions may exhibit a second value of density wherein the first value and second value are different. The difference between the first value of a density and a second value of the density are different by at least about 5% and/or at least about 10% and/or at least about 15% and/or at least about 30% and/or at least about 50%.

In yet another example of a fibrous structure according to the present invention, the visually discernible regions may be generally concentric. “Concentric” as used herein means that the visually discernible regions have a common center, without regard to the shape of the visually discernible regions. Even irregularly shaped visually discernible regions are considered concentric if such visually discernible regions have a common center. It is believed that the concentricity of visually discernible regions draws the eye of a consumer to a readily visually discernible design (pattern) and amplifies its appearance to the observer.

In still another example of a fibrous structure according to the present invention, the visually discernible regions may be generally congruent. “Congruent” as used herein means that the visually discernible regions have a common shape, but may be of different sizes. Generally, congruent visually discernible regions appear to have a common visual theme, and are believed to be more aesthetically pleasing to a consumer than visually discernible regions which bear little similarity in shape to adjacent visually discernible regions.

Any two of the visually discernible regions may be either mutually concentric but not congruent, may be mutually congruent but not concentric or may be neither mutually concentric nor congruent.

Any and all combinations of the arrangements of the discrete, non-linear design elements and/or discrete design elements represented in FIGS. 1-8 can be included in a single fibrous structure of the present invention.

The fibrous structures of the present invention may be incorporated into a single-ply or multi-ply sanitary tissue product.

The fibrous structures may be foreshortened, such as via creping and/or microcontraction and/or rush transferring, or non-foreshortened, such as not creping; creped from a cylindrical dryer with a creping doctor blade, removed from a cylindrical dryer without the use of a creping doctor blade, or made without a cylindrical dryer.

The fibrous structures of the present invention are useful in paper, especially sanitary tissue paper products including, but not limited to: conventionally felt-pressed tissue paper; pattern densified tissue paper; and high-bulk, uncompacted tissue paper. The tissue paper may be of a homogenous or multilayered construction; and tissue paper products made therefrom may be of a single-ply or multi-ply construction.

In one example, the fibrous structure and/or sanitary tissue product of the present invention may exhibit a basis weight of between about 10 g/m² and about 120 g/m², and a density of about 0.150 g/cm³ or less and/or 0.100 g/cm³ or less and/or 0.80 g/cm³ or less and/or 0.60 g/cm³ or less to about 0.010 g/cm³ and/or to about 0.015 g/cm³ and/or to about 0.020 g/cm³.

In another example, the fibrous structure and/or sanitary tissue product of the present invention may exhibit a basis weight below about 35 g/m²; and a density about 0.30 g/cm³ or less. In another example, the fibrous structure and/or sanitary tissue product of the present invention may exhibit a density between about 0.04 g/cm³ and about 0.20 g/cm³.

The fibrous structures may be selected from the group consisting of: through-air-dried fibrous structures, differential density fibrous structures, wet laid fibrous structures, air laid fibrous structures, conventional fibrous structures, meltblown fibrous structures, spunbond fibrous structures, rotary spun fibrous structures and mixtures thereof.

The fibrous structures may be made with a fibrous furnish that produces a single layer embryonic fibrous web or a fibrous furnish that produces a multi-layer embryonic fibrous web.

Fibrous Structure Additives

The fibrous structures of the present invention may comprise, in addition to fibers, an optional additive selected from the group consisting of permanent and/or temporary wet strength resins, dry strength resins, wetting agents, lint resisting agents, absorbency-enhancing agents, immobilizing agents, especially in combination with emollient lotion compositions, antiviral agents including organic acids, antibacterial agents, polyol polyesters, antimigration agents, polyhydroxy plasticizers and mixtures thereof. Such optional additives may be added to the fiber furnish, the embryonic fibrous web and/or the fibrous structure.

Such optional additives may be present in the fibrous structures at any level based on the dry weight of the fibrous structure.

The optional additives may be present in the fibrous structures at a level of from about 0.001 to about 50% and/or from about 0.001 to about 20% and/or from about 0.01 to about 5% and/or from about 0.03 to about 3% and/or from about 0.1 to about 1.0% by weight, on a dry fibrous structure basis.

Processes for Making Fibrous Structures

The fibrous structures of the present invention may be made by any suitable process known in the art.

In one example of a process for making a fibrous structure of the present invention, the process comprises the step of contacting an embryonic fibrous web with a deflection member such that at least one portion of the embryonic fibrous web is deflected out-of-plane of another portion of the embryonic fibrous web. The phrase “out-of-plane” as used herein means that the fibrous structure comprises a protuberance, such as a dome, or a cavity that extends away from the plane of the fibrous structure.

In another example of a process for making a fibrous structure of the present invention, the process comprises the steps of:
(a) providing a fibrous furnish comprising fibers; and
(b) depositing the fibrous furnish onto a deflection member such that at least one fiber is deflected out-of-plane of the other fibers present on the deflection member.

In still another example of a process for making a fibrous structure of the present invention, the process comprises the steps of:
(a) providing a fibrous furnish comprising fibers;
(b) depositing the fibrous furnish onto a foraminous member to form an embryonic fibrous web;
(c) associating the embryonic fibrous web with a deflection member such that at least one fiber is deflected out-of-plane of the other fibers present in the embryonic fibrous web; and
(d) drying said embryonic fibrous web such that that the dried fibrous structure is formed.

In another example of a process for making a fibrous structure of the present invention, the process comprises the steps of:
(a) providing a fibrous furnish comprising fibers;
(b) depositing the fibrous furnish onto a first foraminous member such that an embryonic fibrous web is formed;
(c) associating the embryonic web with a second foraminous member which has one surface (the embryonic fibrous web-contacting surface) comprising a macroscopically monoplanar network surface which is continuous and patterned and which defines a first region of deflection conduits and a second region of deflection conduits within the first region of deflection conduits;
(d) deflecting the fibers in the embryonic fibrous web into the deflection conduits and removing water from the embryonic web through the deflection conduits so as to form an intermediate fibrous web under such conditions that the deflection of fibers is initiated no later than the time at which the water removal through the deflection conduits is initiated; and
(e) optionally, drying the intermediate fibrous web; and
(f) optionally, foreshortening the intermediate fibrous web.

The fibrous structures of the present invention may be made by a process wherein a fibrous furnish is applied to a first foraminous member to produce an embryonic fibrous web. The embryonic fibrous web may then come into contact with a second foraminous member that comprises a deflection member to produce an intermediate fibrous web that comprises a network surface and at least one dome region. The intermediate fibrous web may then be further dried to form a fibrous structure of the present invention.

FIG. 9 is a simplified, schematic representation of one example of a continuous fibrous structure making process and machine useful in the practice of the present invention.

As shown in FIG. 9, one example of a process and equipment, represented as 30 for making a fibrous structure according to the present invention comprises supplying an aqueous dispersion of fibers (a fibrous furnish) to a headbox 32 which can be of any convenient design. From headbox 32 the aqueous dispersion of fibers is delivered to a first foraminous member 34 which is typically a Fourdrinier wire, to produce an embryonic fibrous web 36.

The first foraminous member 34 may be supported by a breast roll 38 and a plurality of return rolls 40, 40′ of which only two are shown. The first foraminous member 34 can be propelled in the direction indicated by directional arrow 42 by a drive means, not shown. Optional auxiliary units and/or devices commonly associated fibrous structure making machines and with the first foraminous member 34, but not shown, include forming boards, hydrofoils, vacuum boxes, tension rolls, support rolls, wire cleaning showers, and the like.

After the aqueous dispersion of fibers is deposited onto the first foraminous member 34, embryonic fibrous web 36 is formed, typically by the removal of a portion of the aqueous dispersing medium by techniques well known to those skilled in the art. Vacuum boxes, forming boards, hydrofoils, and the like are useful in effecting water removal. The embryonic fibrous web 36 may travel with the first foraminous member 34 about return roll 40 and is brought into contact with a deflection member 44, which may also be referred to as a second foraminous member. While in contact with the deflection member 44, the embryonic fibrous web will be deflected, rearranged, and/or further dewatered.

The deflection member 44 may be in the form of an endless belt. In this simplified representation, deflection member 44 passes around and about deflection member return rolls 46, 46′, 46″ and impression nip roll 48 and may travel in the direction indicated by directional arrow 50. Associated with deflection member 44, but not shown, may be various support rolls, other return rolls, cleaning means, drive means, and the like well known to those skilled in the art that may be commonly used in fibrous structure making machines.

Regardless of the physical form which the deflection member 44 takes, whether it is an endless belt as just discussed or some other example such as a stationary plate for use in making handsheets or a rotating drum for use with other types of continuous processes, it must have certain physical characteristics. For example, the deflection member may take a variety of configurations such as belts, drums, flat plates, and the like.

First, the deflection member 44 must be foraminous. That is to say, it must possess continuous passages connecting its first surface 52 (or “upper surface” or “working surface”; i.e. the surface with which the embryonic fibrous web is associated, sometimes referred to as the “embryonic fibrous web-contacting surface”) with its second surface 54 (or “lower surface”; i.e., the surface with which the deflection member return rolls are associated). In other words, the deflection member 44 must be constructed in such a manner that when water is caused to be removed from the embryonic fibrous web 36, as by the application of differential fluid pressure, such as by a vacuum box 56, and when the water is removed from the embryonic fibrous web 36 in the direction of the deflection member 44, the water can be discharged from the system without having to again contact the embryonic fibrous web 36 in either the liquid or the vapor state.

Second, the first surface 52 of the deflection member 44 must comprise a network 58, such as a macroscopically or essentially macroscopically, monoplanar or essentially monoplanar network as represented in one example in FIG. 10. The network 58 may be made by any suitable material. For example, a resin may be used to create the network 58. The network 58 may be continuous, or essentially continuous. The network 58 may be patterned. The network 58 must define within the deflection member 44 a plurality of deflection conduits 60. The deflection conduits 60 may be discrete, isolated, deflection conduits. The network been described as being “macroscopically monoplanar” or “essentially macroscopically monoplanar.” When a surface 62 of the network 58 of the deflection member 44 is placed into a planar configuration, the network surface 62 is essentially monoplanar. It is said to be “essentially” monoplanar to recognize the fact that deviations from absolute planarity are tolerable, but not preferred, so long as the deviations are not substantial enough to adversely affect the performance of the fibrous structure formed on the deflection member 44. The network surface 62 is said to be “continuous” because the areas formed by the network surface 62 must form at least one essentially unbroken net-like pattern. The pattern is said to be “essentially” continuous to recognize the fact that interruptions in the pattern are tolerable, but not preferred, so long as the interruptions are not substantial enough to adversely affect the performance of the fibrous structure made on the deflection member 44.

The deflection conduits 60 of the deflection member 44 may be of any size and shape or configuration. The deflection conduits 60 may repeat in a random pattern or in a uniform pattern. Portions of the deflection member 44 may comprise deflection conduits 60 that repeat in a random pattern and other portions of the deflection member 44 may comprise deflection conduits 60 that repeat in a uniform pattern.

The deflection conduits 60 may comprise two or more classes of deflection conduits. One class of deflection conduits 60′ may translate into (“produce”) the first dome region of a fibrous structure made in accordance with the present invention, for example as shown in FIGS. 3-6. Another class of deflection conduits 60″ may translate into the second dome region of a fibrous structure made in accordance with the present invention, for example as shown in FIGS. 3-6.

The network surface 62 defines openings 64 of the deflection conduits 60.

The network 58 of the deflection member 60 may be associated with a belt, wire or other type of substrate. As shown in FIG. 10, the network 58 of the deflection member 60 is associated with a woven belt 66. Alternatively, the deflection member 44 may consist of solely the network 58. The woven belt 66 may be made by any suitable material, for example polyester, known to those skilled in the art.

As shown in FIG. 11, a cross sectional view of a portion of the deflection member 44 taken along line 11-11 of FIG. 10, the deflection member 44 can be foraminous since the deflection conduits 60 extend completely through the network 58. Further, openings through the deflection member 44 are present in the deflection member 44 since the deflection conduits 60 in combination with interstices present in the woven belt 66 provide openings completely through the deflection member 44.

As shown in FIGS. 10 and 11, the finite shape of the deflection conduits 60 depends on the pattern selected for network surface 62. In other words, the deflection conduits 60 are discretely perimetrically enclosed by network surface 62.

An infinite variety of geometries for the network surface and the openings of the deflection conduits are possible.

Practical shapes of the deflection conduits and/or deflection conduit openings include circles, ovals, and polygons of six or fewer sides. There is no requirement that the openings of the deflection conduits be regular polygons or that the sides of the openings be straight; openings with curved sides, such as trilobal figures, can be used.

In one example of a deflection member in accordance with the present invention, the open area of the deflection member (as measured solely by the open area of the network surface) should be from about 35% to about 85%. The actual dimensions of the open areas of the network surface (in the plane of the surface of the deflection member) can be expressed in terms of effective free span. Effective free span is defined as the area of the opening of the deflection conduit in the plane of the surface of the deflection member divided by one-fourth of the perimeter of the opening of the deflection conduit. Effective free span, for most purposes, should be from about 0.25 to about 3.0 times and/or from about 0.35 to about 2.0 times the average length of the fibers used in the fibrous structure making process.

In one example of a deflection member in accordance with the present invention, at least one and/or a majority and/or all of the deflection conduits that translate into the first dome region of a fibrous structure in accordance with the present invention may have a greatest dimension (the largest geometric dimension of the opening of the deflection conduit) of less than about 100 mils and/or less than about 90 mils and/or less than about 80 mils and/or less than about 60 mils and/or less than about 50 mils. At least one and/or a majority and/or all of the deflection conduits that translate into the second dome region of a fibrous structure in accordance with the present invention may have a minimum dimension (the smallest geometric dimension of the opening of the deflection conduit) of at least about 40 mils and/or at least about 60 mils and/or at least about 70 mils and/or at least about 80 mils and/or at least about 90 mils and/or at least about 100 mils and/or at least about 130 mils).

The dimensions of the deflection conduits are dependent, at least partially, on the type and/or length of fibers used to make the fibrous structures of the present invention. In one example, the dimensions of the deflection conduits are such that pinholes are not created in the fibrous structure made on the deflection member.

In another example of a deflection member in accordance with the present invention, the ratio of the minimum dimension of at least one and/or a majority and/or all of the deflection conduits that translate into the second dome region to the greatest dimension of at least one and/or a majority and/or all of the deflection conduits that translate into the first dome region is greater than about 0.8 and/or greater than about 0.9 and/or greater than about 1.0 and/or greater than about 1.25 and/or greater than about 1.5 and/or greater than about 1.8 and/or greater than about 2.0.

In yet another example of a deflection member in accordance with the present invention, at least one and/or a majority and/or all of the deflection conduits that translate into the second dome region have a minimum dimension that is greater than the greatest dimension of at least one and/or a majority and/or all of the deflection conduits that translate into the first dome region.

As discussed thus far, the network surface and deflection conduits can have single coherent geometries. Two or more geometries can be superimposed one on the other to create fibrous structures having different physical and aesthetic properties. For example, the deflection member can comprise first deflection conduits having openings described by a certain shape in a certain pattern and defining a monoplanar network surface all as discussed above. A second network surface can be superimposed on the first. This second network surface can be coplanar with the first and can itself define second conduits of such a size as to include within their ambit one or more whole or fractional first conduits. Alternatively, the second network surface can be noncoplanar with the first. In further variations, the second network surface can itself be nonplanar. In still further variations, the second (the superimposed) network surface can merely describe open or closed figures and not actually be a network at all; it can, in this instance, be either coplanar or noncoplanar with the network surface. It is expected that these latter variations (in which the second network surface does not actually form a network) will be most useful in providing aesthetic character to the paper web. As before, an infinite number of geometries and combinations of geometries are possible.

In one example, the deflection member of the present invention may be an endless belt which can be constructed by, among other methods, a method adapted from techniques used to make stencil screens. By “adapted” it is meant that the broad, overall techniques of making stencil screens are used, but improvements, refinements, and modifications as discussed below are used to make member having significantly greater thickness than the usual stencil screen.

Broadly, a foraminous member (such as a woven belt) is thoroughly coated with a liquid photosensitive polymeric resin to a preselected thickness. A mask or negative incorporating the pattern of the preselected network surface is juxtaposed the liquid photosensitive resin; the resin is then exposed to light of an appropriate wave length through the mask. This exposure to light causes curing of the resin in the exposed areas. Unexpected (and uncured) resin is removed from the system leaving behind the cured resin forming the network defining within it a plurality of deflection conduits.

In another example, the deflection member can be prepared using as the foraminous member, such as a woven belt, of width and length suitable for use on the chosen fibrous structure making machine. The network and the deflection conduits are formed on this woven belt in a series of sections of convenient dimensions in a batchwise manner, i.e. one section at a time. Details of this nonlimiting example of a process for preparing the deflection member follow.

First, a planar forming table is supplied. This forming table is at least as wide as the width of the foraminous woven element and is of any convenient length. It is provided with means for securing a backing film smoothly and tightly to its surface. Suitable means include provision for the application of vacuum through the surface of the forming table, such as a plurality of closely spaced orifices and tensioning means.

A relatively thin, flexible polymeric (such as polypropylene) backing film is placed on the forming table and is secured thereto, as by the application of vacuum or the use of tension. The backing film serves to protect the surface of the forming table and to provide a smooth surface from which the cured photosensitive resins will, later, be readily released. This backing film will form no part of the completed deflection member.

Either the backing film is of a color which absorbs activating light or the backing film is at least semi-transparent and the surface of the forming table absorbs activating light.

A thin film of adhesive, such as 8091 Crown Spray Heavy Duty Adhesive made by Crown Industrial Products Co. of Hebron, Ill., is applied to the exposed surface of the backing film or, alternatively, to the knuckles of the woven belt. A section of the woven belt is then placed in contact with the backing film where it is held in place by the adhesive. The woven belt is under tension at the time it is adhered to the backing film.

Next, the woven belt is coated with liquid photosensitive resin. As used herein, “coated” means that the liquid photosensitive resin is applied to the woven belt where it is carefully worked and manipulated to insure that all the openings (interstices) in the woven belt are filled with resin and that all of the filaments comprising the woven belt are enclosed with the resin as completely as possible. Since the knuckles of the woven belt are in contact with the backing film, it will not be possible to completely encase the whole of each filament with photosensitive resin. Sufficient additional liquid photosensitive resin is applied to the woven belt to form a deflection member having a certain preselected thickness. The deflection member can be from about 0.35 mm (0.014 in.) to about 3.0 mm (0.150 in.) in overall thickness and the network surface can be spaced from about 0.10 mm (0.004 in.) to about 2.54 mm (0.100 in.) from the mean upper surface of the knuckles of the woven belt. Any technique well known to those skilled in the art can be used to control the thickness of the liquid photosensitive resin coating. For example, shims of the appropriate thickness can be provided on either side of the section of deflection member under construction; an excess quantity of liquid photosensitive resin can be applied to the woven belt between the shims; a straight edge resting on the shims and can then be drawn across the surface of the liquid photosensitive resin thereby removing excess material and forming a coating of a uniform thickness.

Suitable photosensitive resins can be readily selected from the many available commercially. They are typically materials, usually polymers, which cure or cross-link under the influence of activating radiation, usually ultraviolet (UV) light. References containing more information about liquid photosensitive resins include Green et al, “Photocross-linkable Resin Systems,” J. Macro. Sci-Revs. Macro. Chem, C21(2), 187-273 (1981-82); Boyer, “A Review of Ultraviolet Curing Technology,” Tappi Paper Synthetics Conf. Proc., Sep. 25-27, 1978, pp 167-172; and Schmidle, “Ultraviolet Curable Flexible Coatings,” J. of Coated Fabrics, 8, 10-20 (July, 1978). All the preceding three references are incorporated herein by reference. In one example, the network is made from the Merigraph series of resins made by Hercules Incorporated of Wilmington, Del.

Once the proper quantity (and thickness) of liquid photosensitive resin is coated on the woven belt, a cover film is optionally applied to the exposed surface of the resin. The cover film, which must be transparent to light of activating wave length, serves primarily to protect the mask from direct contact with the resin.

A mask (or negative) is placed directly on the optional cover film or on the surface of the resin. This mask is formed of any suitable material which can be used to shield or shade certain portions of the liquid photosensitive resin from light while allowing the light to reach other portions of the resin. The design or geometry preselected for the network region is, of course, reproduced in this mask in regions which allow the transmission of light while the geometries preselected for the gross foramina are in regions which are opaque to light.

A rigid member such as a glass cover plate is placed atop the mask and serves to aid in maintaining the upper surface of the photosensitive liquid resin in a planar configuration.

The liquid photosensitive resin is then exposed to light of the appropriate wave length through the cover glass, the mask, and the cover film in such a manner as to initiate the curing of the liquid photosensitive resin in the exposed areas. It is important to note that when the described procedure is followed, resin which would normally be in a shadow cast by a filament, which is usually opaque to activating light, is cured. Curing this particular small mass of resin aids in making the bottom side of the deflection member planar and in isolating one deflection conduit from another.

After exposure, the cover plate, the mask, and the cover film are removed from the system. The resin is sufficiently cured in the exposed areas to allow the woven belt along with the resin to be stripped from the backing film.

Uncured resin is removed from the woven belt by any convenient means such as vacuum removal and aqueous washing.

A section of the deflection member is now essentially in final form. Depending upon the nature of the photosensitive resin and the nature and amount of the radiation previously supplied to it, the remaining, at least partially cured, photosensitive resin can be subjected to further radiation in a post curing operation as required.

The backing film is stripped from the forming table and the process is repeated with another section of the woven belt. Conveniently, the woven belt is divided off into sections of essentially equal and convenient lengths which are numbered serially along its length. Odd numbered sections are sequentially processed to form sections of the deflection member and then even numbered sections are sequentially processed until the entire belt possesses the characteristics required of the deflection member. The woven belt may be maintained under tension at all times.

In the method of construction just described, the knuckles of the woven belt actually form a portion of the bottom surface of the deflection member. The woven belt can be physically spaced from the bottom surface.

Multiple replications of the above described technique can be used to construct deflection members having the more complex geometries.

The deflection member of the present invention may be made or partially made according to U.S. Pat. No. 4,637,859, issued Jan. 20, 1987 to Trokhan.

As shown in FIG. 9, after the embryonic fibrous web 36 has been associated with the deflection member 44, fibers within the embryonic fibrous web 36 are deflected into the deflection conduits present in the deflection member 44. In one example of this process step, there is essentially no water removal from the embryonic fibrous web 36 through the deflection conduits after the embryonic fibrous web 36 has been associated with the deflection member 44 but prior to the deflecting of the fibers into the deflection conduits. Further water removal from the embryonic fibrous web 36 can occur during and/or after the time the fibers are being deflected into the deflection conduits. Water removal from the embryonic fibrous web 36 may continue until the consistency of the embryonic fibrous web 36 associated with deflection member 44 is increased to from about 25% to about 35%. Once this consistency of the embryonic fibrous web 36 is achieved, then the embryonic fibrous web 36 is referred to as an intermediate fibrous web 68. During the process of forming the embryonic fibrous web 36, sufficient water may be removed, such as by a noncompressive process, from the embryonic fibrous web 36 before it becomes associated with the deflection member 44 so that the consistency of the embryonic fibrous web 36 may be from about 10% to about 30%.

While applicants decline to be bound by any particular theory of operation, it appears that the deflection of the fibers in the embryonic web and water removal from the embryonic web begin essentially simultaneously. Examples can, however, be envisioned wherein deflection and water removal are sequential operations. Under the influence of the applied differential fluid pressure, for example, the fibers may be deflected into the deflection conduit with an attendant rearrangement of the fibers. Water removal may occur with a continued rearrangement of fibers. Deflection of the fibers, and of the embryonic fibrous web, may cause an apparent increase in surface area of the embryonic fibrous web. Further, the rearrangement of fibers may appear to cause a rearrangement in the spaces or capillaries existing between and/or among fibers.

It is believed that the rearrangement of the fibers can take one of two modes dependent on a number of factors such as, for example, fiber length. The free ends of longer fibers can be merely bent in the space defined by the deflection conduit while the opposite ends are restrained in the region of the network surfaces. Shorter fibers, on the other hand, can actually be transported from the region of the network surfaces into the deflection conduit (The fibers in the deflection conduits will also be rearranged relative to one another). Naturally, it is possible for both modes of rearrangement to occur simultaneously.

As noted, water removal occurs both during and after deflection; this water removal may result in a decrease in fiber mobility in the embryonic fibrous web. This decrease in fiber mobility may tend to fix and/or freeze the fibers in place after they have been deflected and rearranged. Of course, the drying of the web in a later step in the process of this invention serves to more firmly fix and/or freeze the fibers in position.

Any convenient means conventionally known in the papermaking art can be used to dry the intermediate fibrous web 68. Examples of such suitable drying process include subjecting the intermediate fibrous web 68 to conventional and/or flow-through dryers and/or Yankee dryers.

In one example of a drying process, the intermediate fibrous web 68 in association with the deflection member 44 passes around the deflection member return roll 46 and travels in the direction indicated by directional arrow 50. The intermediate fibrous web 68 may first pass through an optional predryer 70. This predryer 70 can be a conventional flow-through dryer (hot air dryer) well known to those skilled in the art. Optionally, the predryer 70 can be a so-called capillary dewatering apparatus. In such an apparatus, the intermediate fibrous web 68 passes over a sector of a cylinder having preferential-capillary-size pores through its cylindrical-shaped porous cover. Optionally, the predryer 70 can be a combination capillary dewatering apparatus and flow-through dryer.

The quantity of water removed in the predryer 70 may be controlled so that a predried fibrous web 72 exiting the predryer 70 has a consistency of from about 30% to about 98%.

The predried fibrous web 72, which may still be associated with deflection member 44, may pass around another deflection member return roll 72 and as it travels to an impression nip roll 48. As the predried fibrous web 72 passes through the nip formed between impression nip roll 48 and a surface of the Yankee dryer 74, the network pattern formed by the top surface 52 of deflection member 44 is impressed into the predried fibrous web 72 to form an imprinted fibrous web 76. The imprinted fibrous web 76 can then be adhered to the surface of the Yankee dryer 74 where it can be dried to a consistency of at least about 95%.

The imprinted fibrous web 76 can then be foreshortened by creping the imprinted fibrous web 76 with a creping blade 78 to remove the imprinted fibrous web 76 from the surface of the Yankee dryer 74 resulting in the production of a fibrous structure 80 in accordance with the present invention. As used herein, foreshortening refers to the reduction in length of a dry (having a consistency of at least about 90% and/or at least about 95%) fibrous web which occurs when energy is applied to the dry fibrous web in such a way that the length of the fibrous web is reduced and the fibers in the fibrous web are rearranged with an accompanying disruption of fiber-fiber bonds. Foreshortening can be accomplished in any of several well-known ways. One common method of foreshortening is creping.

Since the network region and the domes are physically associated in the web, a direct effect on the network region must have, and does have, an indirect effect on the domes. In general, the effects produced by creping on the network region (the higher density regions) and the domes (the lower density regions) of the web are different. It is presently believed that one of the most noteable differences is an exaggeration of strength properties between the network region and the domes. That is to say, since creping destroys fiber-fiber bonds, the tensile strength of a creped web is reduced. It appears that in the web of the present invention, while the tensile strength of the network region is reduced by creping, the tensile strength of the dome is concurrently reduced a relatively greater extent. Thus, the difference in tensile strength between the network region and the domes appears to be exaggerated by creping. Differences in other properties can also be exaggerated depending on the particular fibers used in the web and the network region and dome geometries.

Lastly, the fibrous structure 80 may be subjected to post processing steps such as calendering and/or embossing and/or converting.

### NONLIMITING EXAMPLE

A fibrous structure in accordance with the present invention having the following properties: Basis Weight, 19.2 lbs. per 3000 square feet; CD Stretch, 9.1 percent; CD Tensile Strength, 249 grams per 1 inch of sample width; Single Sheet Caliper, 13.2 mils; MD Stretch, 35.2 percent; MD Tensile Strength, 335 grams per 1 inch of sample width; Total Wet Tensile (Finch Cup), 37.4 grams per 1 inch of width, is prepared as follows.

A fiber furnish comprising about 35% bleached northern softwood Kraft fiber, and about 65% hardwood Kraft fiber is prepared. The fiber is pulped for 10 minutes at about 4-5 percent consistency and diluted to about 2.5% to 3.0% percent consistency after pulping. A Parez wet strength additive (commercially available from Bayer in Pittsburgh, Pa.) is added to the bleached northern softwood Kraft fiber thick stock at a rate of about 0.25 lbs./ton pulp and to the hardwood Kraft fiber thick stock at a rate of about 1.0 lbs./ton of pulp. The headbox net slice opening is about 0.650″. The consistency of the stock fed to the headbox is about 0.20 percent consistency. The resulting wet fibrous structure is formed with a fixed-roof former and breast roll and formed on an 84×78 M forming wire (commercially available from Albany International, Appleton, Wis.). The speed of the forming wire is about 12.5 feet per second. The embryonic fibrous structure is then dewatered to a consistency of about 18-19% using vacuum suction before being transferred to a through-drying belt, which is traveling at about 12.5 feet per second. The fibrous structure is then transferred to a deflection member comprising deflection conduits by the suction of a pick-up shoe at a vacuum of about 12-13 inches of mercury. The design is imparted to the fibrous structure as it is deflected into the deflection conduits. The fibrous structure is then carried over a multi-stage suction box with a vacuum of about 12-13 inches of mercury, resulting in an intermediate fibrous structure consistency of about 27%. The intermediate fibrous structure is carried over a through-dryer operating at a temperature of about 335 to 350° F. and dried to a consistency of about 58.5% to produce a predried fibrous structure. The predried fibrous structure is then transferred through an impression nip roll to a Yankee dryer traveling at a speed of about 12.5 feet per second to form an imprinted fibrous structure. The imprinted fibrous structure is then creped from the Yankee dryer surface with a final dryness of at least about 97% consistency to produce a creped fibrous structure. The resulting creped fibrous structure is then tested for physical properties without conditioning. The resulting creped fibrous structure exhibits the following properties.

Test Methods

Dry-Wet Structural Height Test Method

Dry and wet tissue structure heights are measured using a GFM Primos Optical Profiler instrument commercially available from GFMesstechnik GmbH, Warthestraβe 21, D14513 Teltow/Berlin, Germany. The GFM Primos Optical Profiler instrument includes a compact optical measuring sensor based on the digital micro mirror projection, consisting of the following main components: a) DMD projector with 1024×768 direct digital controlled micro mirrors, b) CCD camera with high resolution (1300×1000 pixels), c) projection optics adapted to a measuring area of at least 27×22 mm, and d) recording optics adapted to a measuring area of at least 27×22 mm; a table tripod based on a small hard stone plate; a cold light source; a measuring, control, and evaluation computer; measuring, control, and evaluation software ODSCAD 4.14, English version; and adjusting standards for lateral (x-y) and vertical (z) calibration.

The GFM Primos Optical Profiler system measures the surface height of a sample using the digital micro-mirror pattern projection technique. The result of the analysis is a map of surface height (z) vs. xy displacement. The system has a field of view of 27×22 mm with an xy resolution of 21 microns. The height resolution should be set to between 0.10 and 1.00 micron. The height range is 64,000 times the resolution.

Dry samples require no preparation prior to measurement.

To prepare a wet sample, a 11.33 cm (4.5 inch) wide by 20.32 cm (8 inch) long strip of a fibrous structure or sanitary tissue product to be tested is prepared. First, the sample is measured dry as described below. Holding one end of the sample vertically by the corners, a 10.16 cm (4 inch) long portion of the sample (½ of the length of the sample) at the distal end from where the sample is being held by the corners is dipped slowly and carefully into a pool of water. After the dipped portion of the sample is fully saturated, the saturated portion of the sample is removed from the water and dewatered by carefully laying the saturated portion of the sample on a dry sheet of Bounty® paper towel avoiding any folds or wrinkles in the tissue. After 20 seconds the portion of the sample being dewatered is carefully removed from the sheet of paper towel and placed on a second dry sheet of Bounty® paper towel for 20 seconds. A third dry sheet of Bounty® paper towel is similarly used for an additional 20 seconds. Still while handling the portion of the sample that was not saturated, the portion of the sample that was saturated is carefully laid over a stainless steel square of size 130×130×2 mm with a cut out of 90×90 mm in the center. If necessary, the sample can be very slightly tensioned so that when the stainless steel square is lying on a flat surface the fibrous structure or sanitary tissue product does not sag and/or touch the flat surface. Slightly touching the portion of the sample that was saturated where it contacts the steel square serves to tack the portion of the sample to the square and prevents further movement. The sheet is allowed to air dry for an additional 2 minutes prior to measurement as described below.

To measure a fibrous structure sample or sanitary tissue product sample do the following:
1. Turn on the cold light source. The settings on the cold light source should be 4 and C, which should give a reading of 3000K on the display;
2. Turn on the computer, monitor and printer and open the ODSCAD 4.14 Software.
3. Select “Start Measurement” icon from the Primos taskbar and then click the “Live Pic” button.
4. Place the sample under the projection head, center the features of interest within the field of view of the live image, and adjust the distance for best focus.
5. Click the “Pattern” button repeatedly to project one of several focusing patterns to aid in achieving the best focus (the software cross hair should align with the projected cross hair when optimal focus is achieved). Position the projection head to be normal to the sample surface.
6. For dry samples, with a permanent marker, place small dots on the sample at the corners of the illumination square. For the wet samples, use the four previous marks to realign the features of interest with the field of view.
7. Adjust image brightness by changing the aperture on the lens through the hole in the side of the projector head and/or altering the camera “gain” setting on the screen. Do not set the gain higher than 7 to control the amount of electronic noise. When the illumination is optimum, the red circle at bottom of the screen labeled “I.O.” will turn green.
8. Select Standard measurement type.
9. Click on the “Measure” button. This will freeze on the live image on the screen and, simultaneously, the image will be captured and digitized. It is important to keep the sample still during this time to avoid blurring of the captured images. The images will be captured in approximately 20 seconds.
10. If the height image is satisfactory, save the image to a computer file with “.omc” extension. This will also save the camera image file “.kam”.
11. To move the data into the analysis portion of the software, click on the clipboard/man icon.
12. Now, click on the icon “Draw lines” or “Draw freehand line” as needed. For samples where the raised structures lie in a straight line, select the starting and ending line points with the mouse so that the marked line traverses several features. If the raised structures are not on a straight line, use the freehand line tool to mark points in the centers of the structures such that the structures will be connected with a curved line. Once the line is created, select “Show sectional line diagram” to create a plot of the height versus distance along the line. Use the “Vertical distance” tool to mark a point in the baseline region between structures, and a point at the top of the structure and record the height calculated. Repeat the measurement for each structure along the line. The average height of the features is reported in micron units.
   Opacity Test Method

To directly quantify relative differences in opacity, a Nikon stereomicroscope, model SMZ-2T sold by the Nikon Company, of New York, N.Y. is used in conjunction with a C-mounted Dage MTI of Michigan City, Ind. model NC-70 video camera. The image from the microscope is stereoscopically viewed through the oculars or viewed in two dimensions on a computer monitor. The analog image data from the camera attached to the microscope is digitized by a video card made by Data Translation of Marlboro, Mass. and analyzed on a Macintosh IIx computer made by the Apple Computer Co. of Cupertino, Calif. Suitable software for the digitization and analysis is IMAGE, version 1.31, available from the National Institute of Health, in Washington, D.C.

By using the mean density options of the IMAGE software to measure the opacity, relative differences in opacity are easily obtained due to the attenuation of light passing through various regions of interest of a fibrous structure and/or sanitary tissue product sample. The mean density option gives the grey level value of a particular region under consideration as the mean pixel grey level value of that region. The pixels have a grey level range from 0 (pure black) to 255 (pure white).

Without the sample on the microscope stage, the room lights are darkened and the microscope source light intensity is adjusted to make the grey levels of the regions fall within the range of 0 to 255. The lighting is optimized to make the background distribution of grey levels both narrow and as close to zero as possible. The sample is placed on the microscope stage at approximately 10× magnification. To account for variations in the background lighting, it is subtracted from each of the actual sample images. After this background subtraction, the region of interest is then defined using the mouse and the mean grey level value read directly from the monitor.

If desired, absolute opacity of the various regions is determined by calibrating IMAGE with optical density standards.

Crepe Frequency Test Method

The crepe frequency of a fibrous structure and/or sanitary tissue product may be measured utilizing the aforementioned Nikon stereomicroscope, the Dage camera and the IMAGE data analysis software, in conjunction with a Data Translation of Marlboro, Mass. Model DT2255 frame grabber card. The system is calibrated using a ten millimeter optical micrometer and a ruler tool and by drawing a line between two points separated by a known distance. The scale is then sent to this distance. After calibrating, the magnification of the microscope is set to 70×.

A sample of the fibrous structure and/or sanitary tissue product to be examined is placed on the stage of the microscope and focused without changing magnification. Using the ruler tool of the IMAGE program, the distance between two points of interest are measured. The reciprocal of this measurement is recorded as a crepe frequency datum point and the measurement repeated sufficient times to assure statistically significant data are obtained.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure comprising a surface and a design wherein the design comprises a plurality of discrete, non-linear design elements, wherein the discrete, non-linear design elements are spatially associated with one another such that the plurality of discrete, non-linear design elements form a linear design element within the design and wherein the design encompasses less than the entire surface area of the surface of the fibrous structure.

2. The fibrous structure according to claim 1 wherein at least one of the discrete, non-linear design elements exhibits a ratio of wet structure height to dry structure height of at least about 0.3.

3. The fibrous structure according to claim 1 wherein the design comprises a plurality of linear design elements formed from a plurality of discrete, non-linear design elements.

4. The fibrous structure according to claim 1 wherein at least one of the plurality of discrete, non-linear design elements exhibits a minimum dimension of at least 40 mils.

5. The fibrous structure according to claim 1 wherein the fibrous structure exhibits a difference in value in an intensive property of the fibrous structure between at least one of the plurality of discrete, non-linear design elements and an adjacent region on the surface of the fibrous structure.

6. A fibrous structure comprising:
a. a network region;
b. a first dome region comprising at least one dome;
c. a second dome region comprising three or more domes,
wherein a different value for an intensive property exists between the network region and the first dome region and/or the network region and the second dome region and/or the first dome region and the second dome region.

7. The fibrous structure according to claim 6 wherein the at least one dome of the first dome region is encompassed by the network region.

8. The fibrous structure according to claim 6 wherein the first dome region comprises a plurality of domes.

9. The fibrous structure according to claim 6 wherein the three or more domes of the second dome region form a design element of a design.

10. A fibrous structure comprising a design, wherein the design comprises at least three discrete, non-linear design elements spatially arranged to form a linear design element wherein at least one of the at least three discrete, non-linear design elements consists of two visually discernible regions.

11. The fibrous structure according to claim 10 wherein the fibrous structure comprises a background matrix.

12. The fibrous structure according to claim 11 wherein the at least discrete, non-linear design elements are superimposed on the background matrix.

13. The fibrous structure according to claim 11 wherein the background matrix of the fibrous structure is adjacent to at least one of the at least three discrete, non-linear design elements.

14. A method for making a fibrous structure comprising the step of forming a fibrous structure comprising a design comprising at least three discrete, non-linear design elements spatially arranged to visually represent a linear design element.

15. A fibrous structure comprising a surface and a design wherein the design comprises at least one and/or at least two and/or at least three discrete, non-linear design elements, wherein at least one of the discrete, non-linear design elements remains after the design element has been contacted by water, wherein the design encompasses less than the entire surface area of the surface of the fibrous structure.
